(19) United States
(12) Patent Application Publication
(10) Pub. No.: US 2003/0233314 A1
(43) Pub. Date: Dec. 18, 2003

(54) General montage layout

(76) Inventors: Christopher Kokis, Monroe, CT (US); Robert A. Waghorne, Fairfield, CT (US); Gene A. Ryan, Shelton, CT (US); Natalya Okunev, Brooklyn, NY (US)

Correspondence Address: DENIS G. MALONEY, Fish & Richardson P.C., 225 Franklin Street, Boston, MA, 02110-2804, US

(21) Appl. No.: 10/294,477

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/37

(57) ABSTRACT

A montage display process includes an ask-side display process for displaying, in a multi-column format, an ask-side entry for a specific security that is offered for sale by a market participant on a securities market. This ask-side entry includes a market participant identifier, a lot size, and an ask price. A bid-side display process displays, in a multi-column format, a bid-side entry for the specific security that is wanted for purchase by a market participant on a securities market. This bid-side entry includes a market participant identifier, a lot size, and a bid price. The bid-side display process is configured to display the bid-side entry such that it is essentially a mirror image of the ask-side entry.

### RELATED APPLICATIONS

This application claims the priority of: U.S. Provisional Patent Application No. 60/335,388, entitled “Super Montage”, and filed on Nov. 14, 2001; U.S. Provisional Patent Application No. 60/385,979, entitled “Supermontage Architecture”, and filed on Jun. 5, 2002; and U.S. Provisional Patent Application No. 60/385,988, entitled “Security Processor”, and filed on Jun. 5, 2002.

### BACKGROUND

This invention relates to electronic securities trading, and the processing and displaying of information relating to electronic securities trading.

Electronic equity markets, such as The Nasdaq Stock Market™ collect, aggregate, and display pre-trade information to market participants. In the Nasdaq Stock Market, for example, this pre-trade information takes the form of a quote that represents a single or an aggregate of same-priced principal or agency orders. A market, such as The Nasdaq Stock Market™, also provides trading platforms through which market participants may trade securities in the marketplace.

### SUMMARY

According to an aspect of this invention, a montage display process includes an ask-side display process for displaying, in a multi-column format, an ask-side entry for a specific security that is offered for sale by a market participant on a securities market. This ask-side entry includes a market participant identifier, a lot size, and an ask price. A bid-side display process displays, in a multi-column format, a bid-side entry for the specific security that is wanted for purchase by a market participant on a securities market. This bid-side entry includes a market participant identifier, a lot size, and a bid price. The bid-side display process is configured to display the bid-side entry such that it is essentially a mirror image of the ask-side entry.

One or more of the following features may also be included. The ask-side display process includes a tabular display process for simultaneously displaying multiple ask-side entries in an ask-side table. The ask-side display process includes a tabular sorting process for sorting the multiple ask-side entries in accordance with a user-defined sorting parameter, such as the market participant identifier, the lot size, or the ask price. An ask-side aggregate calculation process generates an ask-side aggregate value for a specific ask-side entry, such that the ask-side aggregate value is equal to the lot size of the specific ask-side entry summed with the lot sizes of all preceding ask-side entries included in the ask-side table. An ask-side selection process allows a market participant to select groups of the ask-side entries that have a common ask price.

The bid-side display process includes a tabular display process for simultaneously displaying multiple bid-side entries in a bid-side table. The bid-side display process includes a tabular sorting process for sorting the multiple bid-side entries in accordance with a user-defined sorting parameter, such as the market participant identifier, the lot size, and the bid price. A bid-side aggregate calculation process generates a bid-side aggregate value for a specific bid-side entry, such that the bid-side aggregate value is equal to the lot size of the specific bid-side entry summed with the lot sizes of all preceding bid-side entries included in the bid-side table. A bid-side selection process allows a market participant to select groups of bid-side entries that have a common bid price.

A security selection process allows a market participant of the montage display process to select the specific security, and a security data display process displays trade data concerning that specific security The trade data includes a trade volume amount, a low trade amount, and a high trade amount.

According to a further aspect of this invention, a montage display method includes displaying an ask-side entry, in a multi-column format, for a specific security that is offered for sale by a market participant on a securities market. This ask-side entry includes a market participant identifier, a lot size, and an ask price. A bid-side entry is also displayed, in a multicolumn format, for the specific security that is wanted for purchase by the market participant on a securities market. This bid-side entry, which includes a market participant identifier, a lot size, and a bid price, is displayed so that it is essentially a mirror image of the ask-side entry.

One or more of the following features may also be included. Displaying an ask-side entry includes simultaneously displaying multiple ask-side entries in an ask-side table. Displaying an ask-side entry includes sorting the multiple ask-side entries in accordance with a user-defined sorting parameter. An ask-side aggregate value is generated for a specific ask-side entry, such that the ask-side aggregate value is equal to the lot size of that specific ask-side entry summed with the lot sizes of all preceding ask-side entries included in the ask-side table. A market participant is allowed to select groups of ask-side entries that have a common ask price.

Displaying a bid-side entry includes simultaneously displaying multiple bid-side entries in a bid-side table. Displaying a bid-side entry includes sorting the multiple bid-side entries in accordance with a user-defined sorting parameter. A bid-side aggregate value is generated for a specific bid-side entry, such that the bid-side aggregate value is equal to the lot size of that specific bid-side entry summed with the lot sizes of all preceding bid-side entries included in the bid-side table.

A market participant is allowed to select groups of the bid-side entries that have a common bid price. Further, a market participant is allowed to select the specific security and trade data concerning that specific security is displayed.

According to a further aspect of this invention, a computer program product residing on a computer readable medium has a plurality of instructions stored on it. When executed by the processor, these instructions cause that processor to display an ask-side entry, in a multi-column format, for a specific security that is offered for sale by a market participant on a securities market. This ask-side entry includes a market participant identifier, a lot size, and an ask price. A bid-side entry is displayed in a multi-column format for the specific security that is wanted for purchase by a market participant on a securities market. This bid-side entry, which includes a market participant identifier, a lot size, and a bid price, is essentially a mirror image of the ask-side entry.

One or more of the following features may also be included. The instructions to display an ask-side entry further includes instructions to sort multiple ask-side entries in accordance with a user-defined sorting parameter. The computer program product further includes instructions to allow a market participant to select groups of ask-side entries that have a common ask price.

The instructions to display a bid-side entry further includes instructions to sort multiple bid-side entries in accordance with a user-defined sorting parameter. The computer program product further includes instructions to allow a market participant to select groups of bid-side entries that have a common ask price.

The computer program product further includes instructions to generate an aggregate value for a specific bid-side or ask side entry, such that this bid-side or ask side aggregate value is equal to the lot size of that specific bid-side or ask side entry summed with the lot sizes of all preceding bid-side or ask side entries included in a bid-side or ask side table.

One or more advantages can be provided from the above. The market participant can quickly and easily monitor all trading activity for a specific security. Further, selecting blocks of securities is simplified via a group selection process. Additionally, by configuring the ask-side and bid-side of the display so that they are mirror images of each other, usability is increased due to easier readability and understandability. By providing the market participant with trade data concerning the security being monitored, the market participant is better able to judge the condition of the market concerning that specific security.

### DESCRIPTION OF DRAWINGS

FIG. 1 is a block diagram of a montage display process;

FIG. 2 is a diagrammatic view of a montage display; and

FIG. 3 is a block diagram of a montage display method.

### DETAILED DESCRIPTION

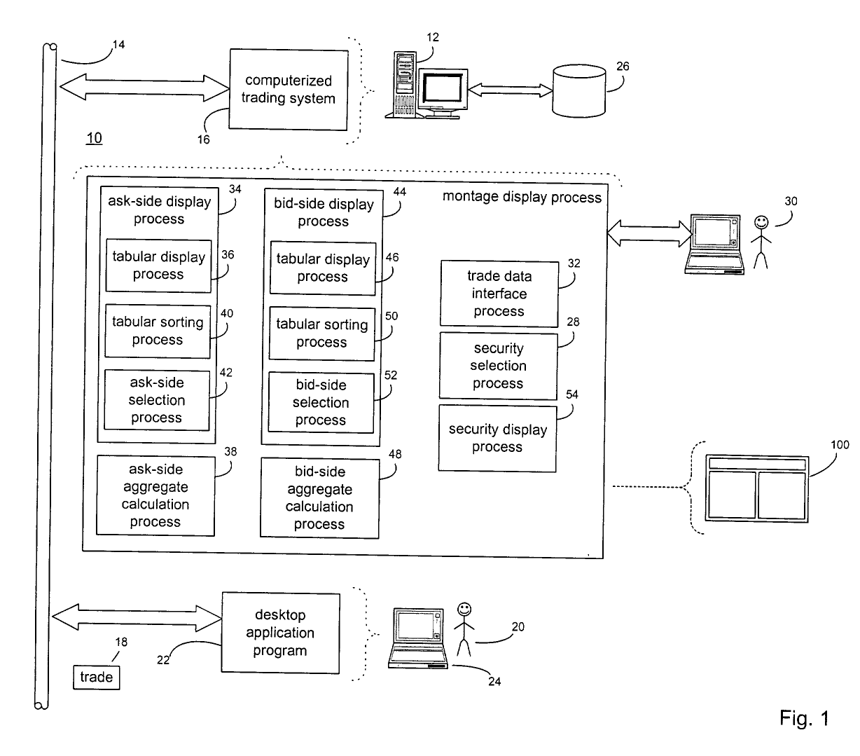

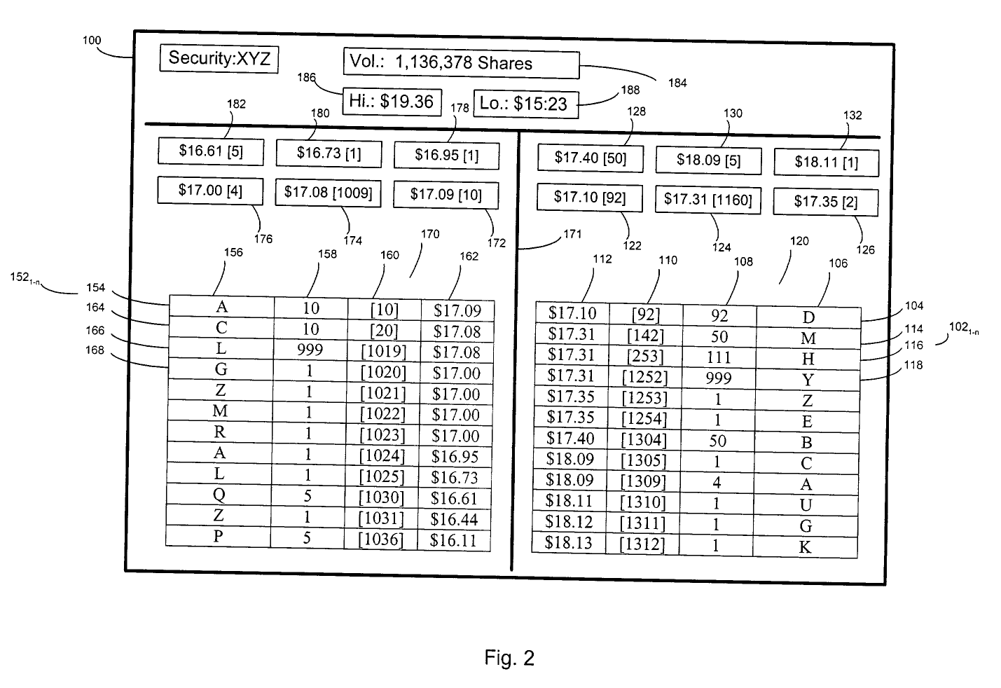

Referring to FIGS. 1 and 2, there is shown a montage display process 10. Montage display process 10 resides on server 12 that is connected to a distributed computing network 14 (e.g., the Internet, an intranet, a local area network, or some other form of network). Computerized trading system 16 (e.g., The Nasdaq Stock Market™), which trades securities electronically and also resides on server 12, processes trades 18 entered by market participant 20. Market participant 20 typically accesses and uses computerized trading system 16 via a desktop application 22 (e.g., Microsoft Internet Explorer™, Netscape Navigator™, the Nasdaq Workstation II™, a specialized desktop interface, etc.) residing on a computer 24, thus allowing market participant 20 to trade securities with other market participants (not shown).

Montage display process 10 allows market participant 20 to monitor the trading activity for a specific security traded on computerized trading system 16, by providing market participant 20 with a summarized display 100 (to be discussed below in greater detail) viewable on computer 24. Typically, summarized display 100 is one screen in size, thus allowing market participant 20 to quickly get an overview of the activity of the specific security without having to scroll through or toggle between multiple screens.

Process 10 typically resides on a storage device 26 connected to server 12. Storage device 26 can be a hard disk drive, a tape drive, an optical drive, a RAID array, a random access memory (RAM), or a read-only memory (ROM), for example. Additionally, computerized trading system 16 stores all information relating to securities trades on storage device 26.

Process 10 includes a security selection process 28 that allows market participant 20 to select the specific security they wish to monitor. This selection may occur is several different ways and will vary depending on the manner in which process 10 is implemented and configured by administrator 30. For example, market participant 20 may select the security they wish to monitor via a drop-down menu that allows the market participant to scroll through a list of securities and select the one they wish to monitor. This drop down menu may utilize ticker symbols or may list the full name of the issuer of the security. Alternatively, market participant 20 may wish to enter the security's ticker symbol directly, thus allowing for quicker selection.

Once a selection is made, a trade data interface process 32 retrieves, from storage device 26 of server 12, the relevant trade data concerning the security selected by market participant 20. Typically, summarized display 100 is a real-time display, in that the information shown within the display is regularly updated (at a frequency defined by administrator 30) so that it is always accurate and up to date. Accordingly, trade data interface process 32 typically establishes a connection (i.e., a socket) with computerized trading system 16 so that the information provided in display 100 is always relevant and up-to-date.

Once a connection is established by trade data interface process 32 and the relevant trade data is retrieved, summarized display 100 is generated. As stated above, summarized display 100 allows market participant 20 to quickly and easily discern the trading activity associated with the specific security that market participant 20 wishes to monitor.

An ask-side display process 34 displays, in a multi-column format, ask-side entries 102₁₋ₙ for the security that was selected by market participant 20, and is currently being traded on computerized trading system 16. Each discrete ask-side entry 102₁₋ₙ represents a discrete group of the specific security selected by market participant 20, such that these groups of securities are being offered for sale by another market participant. For example, ask-side entry 104 concerns a group of ninety-two shares of the security XYZ corp. that is currently being offered for sale by Market participant D. Ask-side entry 104 includes multiple columns, each of which provides information concerning the discrete group of securities being offered for sale, such as a market participant indicator 106 (i.e., a unique symbol that identifies the market participant who is offering the security for sale), an ask price 112, a lot size 108 (i.e., the quantity of shares of the selected security available at that ask price from that market participant), and an aggregate value 110 (i.e., the total sum of shares available at that price or lower).

Ask-side display process 34 includes a tabular display process 36 for simultaneously displaying multiple ask-side entries (e.g., ask-side entries 104, 114, 116, 118). These ask-side entries are arranged vertically so that the market indicator, ask price, lot size, and aggregate value of each entry are aligned, forming ask-side table 120.

Therefore, for this particular summarized display 100, if market participant 20 is willing to pay up to $17.10 for a share of XYZ corp., market participant 20 could buy up to ninety-two shares from Market participant D. This is shown in ask-side entry 104. However, if market participant 20 desires a ninety-third share of XYZ corp., market participant 20 is going to have to pay $17.31 for that one additional share, since Market participant D only has ninety-two shares for sale at $17.10 and the additional share is going to have to be purchased from Market participant M for $17.31 (see ask-side entry 114). If, upon realizing that additional shares of XYZ corp. can be purchased for $17.31, market participant 20 wishes to purchase an additional one-hundred shares of XYZ corp., this is not a problem, as Market participant M has fifty shares of XYZ corp. for sale for $17.31, Market participant H has an additional one-hundred-eleven shares available for $17.31, and Market participant Y has nine-hundred-ninety-nine shares available for $17.31. Therefore, a total of eleven-hundred-sixty shares of XYZ corp. are available for $17.31.

Process 10 includes an ask-side aggregate calculation process 38 for calculating the ask-side aggregate value 110 for each ask-side entry. Ask-side aggregate calculation process 38 determines the ask-side aggregate value 110 for a particular ask-side entry by summing the value of the lot size for that particular ask-side entry with the lot sizes of all preceding ask-side entries included in ask-side table 120. For example, the aggregate value for ask-side entry 104 is [92], the aggregate value for ask-side entry 114 is [142, i.e., 92+50], the aggregate value for ask-side entry 116 is [253, i.e., 92+50+111], and so forth.

A tabular sorting process 40 sorts ask-side entries (e.g., 104, 114, 116, 118) in accordance with a user-defined sorting parameter, such as ascending or descending ask prices, alphanumeric market participant ID's, ascending or descending lot sizes, for example. This enables market participant 20 to group and order the ask-side entries within ask-side table 120 in accordance with their personal preferences. For example, it market participant 20 wanted to know which groups of securities a particular market participant was offering for sale, market participant 20 could sort the ask-side entries by market participant. However, the ask-side entries within ask-side table 120 are typically sorted by ask price (as shown in FIG. 2).

An ask-side selection process 42 allows a market participant 20 to select (typically for purchase) groups of ask-side entries that have a common ask price. In order to facilitate this market participant selection, summarized display 100 includes group selection buttons 122, 124, 126, 128, 130, 132 that are each are assigned to a particular ask price. These buttons are dynamically updated by ask-side selection process 42 so that they accurately reflect the securities (e.g., XYZ corp.) currently being offered for sale on computerized trading system 16. For example, group selection button 122 represents shares of XYZ corp. available for $17.10. As discussed above, there are ninety-two of them, as represented by ask-side entry 104. Group selection button 124 represents shares of XYZ corp. available for $17.31. There are eleven-hundred-sixty of them, as represented by ask-side entries 114, 116, 118. By clicking on or otherwise selecting (with a mouse or other pointing device, not shown) any of these group selection buttons, market participant 20 can select groups of shares available at a particular ask price. As stated above, these buttons are dynamically updated, so that if ask-side entry 104 is sold (i.e., purchased by another market participant), there would be no more shares of XYZ corp. available for $17.10 and, therefore, group selection button 122 would be removed by ask-side selection process 42. Further, assuming that no additional shares of XYZ corp. became available at a price lower than $17.31, an additional group selection button (not shown) would be created that would indicate one share of XYZ corp. being available from Market participant G for $18.12. Typically, group selection buttons 126, 128, 130, 132, 134, 136 are organized so that the ask price that each button is associated with increases as market participant 20 moves along any row of buttons from left to right.

In a manner similar to ask-side display process 34, a bid-side display process 44 displays, in a multi-column format, bid-side entries 152₁₋ₙ for the same security (i.e., XYZ corp.) that was selected by market participant 20. Each discrete bid-side entry 152₁₋ₙ represents a discrete group of the specific security (selected by market participant 20) that is wanted for purchase by another market participant of computerized trading system 16. For example, bid-side entry 154 concerns a group of ten shares of the security XYZ corp. that a market participant (i.e., Market participant A) currently wants to purchase. Similar to an ask-side entry, a bid-side entry 154 includes multiple columns, each of which provides information concerning the discrete group of securities wanted for purchase, such as a market participant indicator 156 (i.e., a unique symbol that identifies the market participant who wants to purchase the security), a bid price 162, a lot size 158 (i.e., the quantity of shares of the selected security wanted for purchase by that market participant at that bid price), and an aggregate value 160 (i.e., the total sum of shares wanted for purchase at that price or higher).

Bid-side display process 44 includes a tabular display process 46 for simultaneously displaying multiple bid-side entries (e.g., bid-side entries 154, 164, 166, 168). These bid-side entries are arranged vertically so that the market indicator, bid price, lot size, and aggregate value of each entry are aligned, forming an bid-side table 170.

Therefore, for this particular summarized display 100, if market participant 20 owns two-thousand shares of XYZ corp. that they are willing to sell but they do not want to sell them for less than $17.09 per share, market participant 20 can only sell ten shares to Market participant A, as bid-side entry 154 specifies that $17.09 is the highest dollar amount offered to buy a share of XYZ corp. and Market participant A is only willing to purchase ten shares at that price. However, if market participant 20 is willing to lower their sell price to $17.08 per share, market participant 20 can sell one-thousand-nineteen shares of XYZ corp. at that price. Specifically, Market participant A is willing to buy ten shares for $17.09 (see bid-side entry 154), Market participant C is willing to buy ten shares for $17.08 (see bid-side entry 164), and Market participant L is willing to buy nine-hundred-ninety-nine shares for $17.08 (see bid-side entry 166).

Process 10 includes an bid-side aggregate calculation process 48 for calculating the bid-side aggregate value 160 for each bid-side entry. As with ask-side aggregate calculation process 38, bid-side aggregate calculation process 48 determines the bid-side aggregate value 160 for a particular bid-side entry by summing the value of the lot size for that particular bid-side entry with the lot sizes of all preceding bid-side entries included in bid-side table 170. For example, the aggregate value for bid-side entry 154 is [10], the aggregate value for bid-side entry 164 is [20, i.e., 10+10], the aggregate value for bid-side entry 166 is [1019, i.e., 10+10+999], and so forth.

Similar to that of ask-side entries, a tabular sorting process 50 sorts bid-side entries (e.g., 154, 164, 166, 168) in accordance with a user-defined sorting parameter, such as ascending or descending bid prices, alphanumeric market participant ID's, ascending or descending lot sizes, etc. This enables market participant 20 to group and order the bid-side entries within bid-side table 170 in accordance with their personal preferences. Again, like ask-side table 120, bid-side entries within bid-side table 170 are typically sorted by bid price (as shown in FIG. 2).

Bid-side display process 44 displays bid-side entries so that bid-side table 170 is essentially a mirror image of ask-side table 120. Specifically, the columns in bid-side table 170 are arranged in a fashion so that they are in the opposite order (i.e., when moved across the tables 120, 170 in a common direction) to that of ask-side table 120. The columns of these tables are essentially mirrored around an imaginary centerline 171. For example, column 112 and column 162 (i.e., ask prices and bid prices respectively) are the closest columns to centerline 171. Column 110 and column 160 (i.e., ask-side and bid-side aggregate values respectively) are the second closest columns to centerline 171. Further, column 108 and column 158 (i.e., ask-side and bid-side lot sizes respectively) are the third closest columns to centerline 171. And finally, column 106 and column 156 (i.e., ask-side and bid-side market participant ID's respectively) are the furthest columns away from centerline 171.

A bid-side selection process 52 allows a market participant 20 to select (typically for the purpose of selling the market participant's securities) groups of bid-side entries that have a common bid price. In order to facilitate this market participant selection, summarized display 100 includes group selection buttons 172, 174, 176, 178, 180, 182 that each are assigned to a particular bid price. The buttons are dynamically updated by bid-side selection process 52 so that they accurately reflect the securities currently wanted for purchase. For example, group selection button 172 represents shares wanted for purchase at $17.09. As discussed above, there are ten of them, as represented by bid-side entry 154. Group selection button 174 represents shares available for $17.08. There are one-thousand-nine of them, as represented by bid-side entries 164, 166. By clicking on or otherwise selecting (with a mouse or other pointing device, not shown) any of these group selection buttons, market participant 20 can select groups of shares that the other market participant (i.e., the market participant of the bid-side entry) wishes to purchase for a particular bid price.

These buttons are also dynamically updated, so that if bid-side entry 154 is filled (i.e., someone else sold Market participant A ten shares of XYZ corp. for $17.09 per share), there would be no more market participants willing to pay $17.09 for a share of XYZ corp. and, therefore, group selection button 172 would be removed by bid-side selection process 52. Further, assuming that no other market participants were willing to pay more than $17.08 for a share of XYZ corp., an additional group selection button (not shown) would be created that would indicate that a market participant (i.e., Market participant Z) was willing to pay $16.44 for one share of XYZ corp. Typically, group selection buttons 172, 174, 176, 178, 180, 182 are organized so that the bid price that each button is associated with decrease as market participant 20 moves along any row of buttons from right to left, an arrangement that is a mirror image of the ask-side group selection buttons (i.e., 122, 124, 126, 128, 130, 132).

A security display process 54 displays, in summarized display 100, pertinent trade data relating to the specific security (e.g., XYZ corp.) being monitored by market participant 20. Examples of this pertinent trade data, which is retrieved from computerized trading system 16, include a daily trade volume amount indicator 184, daily high trade amount indicator 186, and daily low trade value amount indicator 188.

While the group selection buttons are shown arranged in groups of six, this is an arbitrary amount, as this number can be adjusted depending on the requirement of market participant 20 and administrator 30.

While the lot sizes 108, 158 described above are stated to be in units of shares, it is possible for these numbers to also represent groups of one-hundred shares (commonly referred to as “round lots”), or any other amount of shares. In this scenario, ask-side entry 104 may represent an offer to sell ninety-two-hundred shares of XYZ corp.

While imaginary centerline 171 is shown as being a vertical centerline, this imaginary centerline 171 may be a horizontal centerline, such that ask-side and bid-side entries are arranged in multi-row format and, therefore, mirroring would occur about a horizontal axis.

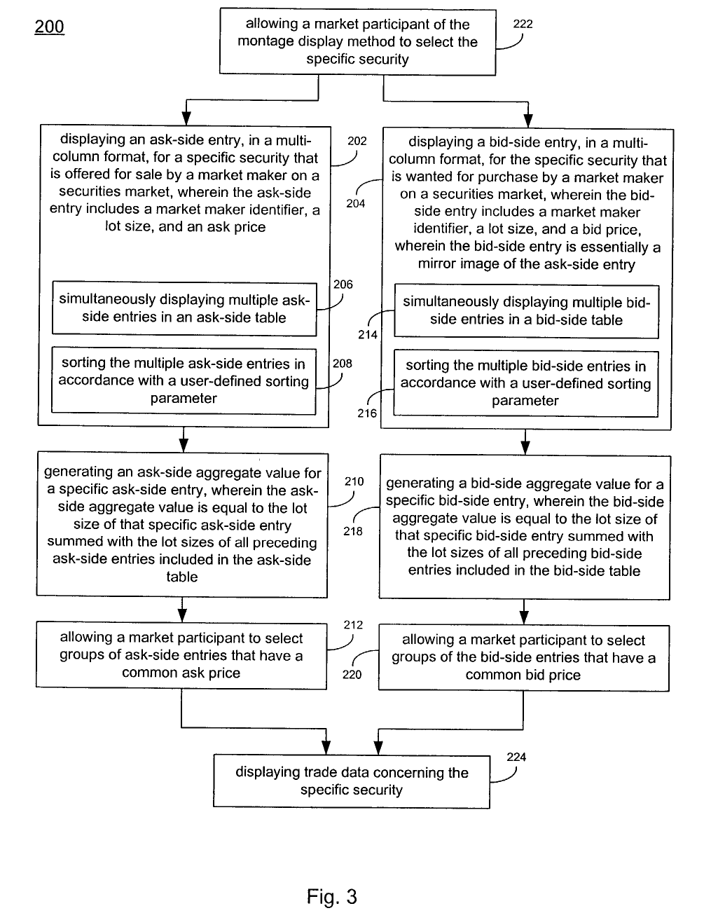

Referring to FIG. 3, there is shown a montage display method 200. An ask-side entry is displayed 202, in a multi-column format, for a specific security that is offered for sale by a market participant on a securities market. This ask-side entry includes a market participant identifier, a lot size, and an ask price. A bid-side entry is displayed 204, in a multi-column format, for the specific security that is wanted for purchase by a market participant on a securities market. This bid-side entry, which includes a market participant identifier, a lot size, and a bid price, is essentially a mirror image of the ask-side entry.

Displaying 202 the ask-side entry includes simultaneously displaying 206 multiple ask-side entries in an ask-side table and sorting 208 these multiple ask-side entries in accordance with a user-defined sorting parameter. An ask-side aggregate value is generated 210 for a specific ask-side entry, such that the ask-side aggregate value is equal to the lot size of that specific ask-side entry summed with the lot sizes of all preceding ask-side entries included in the ask-side table. A market participant is allowed 212 to select groups of ask-side entries that have a common ask price.

Displaying 204 a bid-side entry includes simultaneously displaying 214 multiple bid-side entries in a bid-side table and sorting 216 these multiple bid-side entries in accordance with a user-defined sorting parameter. A bid-side aggregate value is generated 218 for a specific bid-side entry, such that the bid-side aggregate value is equal to the lot size of that specific bid-side entry summed with the lot sizes of all preceding bid-side entries included in the bid-side table. A market participant is allowed 220 to select groups of the bid-side entries that have a common bid price.

Additionally, a market participant of the montage display method is allowed 222 to select the specific security to be monitored. Further, trade data concerning the specific security being monitored is displayed 224.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

A number of embodiments of the invention have been described. Nevertheless, it will be understood that various modifications may be made without departing from the spirit and scope of the invention.

What is claimed is:

1. A montage display process comprising:
an ask-side display process for displaying, in a multi-column format, an ask-side entry for a specific security that is offered for sale by a market participant on a securities market, wherein said ask-side entry includes a market participant identifier, a lot size, and an ask price; and
a bid-side display process for displaying, in a multi-column format, a bid-side entry for said specific security that is wanted for purchase by a market participant on a securities market, wherein said bid-side entry includes a market participant identifier, a lot size, and a bid price;
wherein said bid-side display process is configured to display said bid-side entry such that it is essentially a mirror image of said ask-side entry.

2. The montage display process of claim 1 wherein said ask-side display process includes a tabular display process for simultaneously displaying multiple ask-side entries in an ask-side table.

3. The montage display process of claim 2 wherein said ask-side display process includes a tabular sorting process for sorting said multiple ask-side entries in accordance with a user-defined sorting parameter.

4. The montage display process of claim 3 wherein said user-defined sorting parameter is chosen for the group consisting of: said market participant identifier; said lot size; and said ask price.

5. The montage display process of claim 2 further comprising an ask-side aggregate calculation process for generating an ask-side aggregate value for a specific ask-side entry, wherein said ask-side aggregate value is equal to the lot size of said specific ask-side entry summed with the lot sizes of all preceding ask-side entries included in said ask-side table.

6. The montage display process of claim 2 further comprising an ask-side selection process for allowing a market participant to select groups of said ask-side entries that have a common ask price.

7. The montage display process of claim 1 wherein said bid-side display process includes a tabular display process for simultaneously displaying multiple bid-side entries in a bid-side table.

8. The montage display process of claim 7 wherein said bid-side display process includes a tabular sorting process for sorting said multiple bid-side entries in accordance with a user-defined sorting parameter.

9. The montage display process of claim 8 wherein said user-defined sorting parameter is chosen for the group consisting of: said market participant identifier; said lot size; and said bid price.

10. The montage display process of claim 7 further comprising a bid-side aggregate calculation process for generating a bid-side aggregate value for a specific bid-side entry, wherein said bid-side aggregate value is equal to the lot size of said specific bid-side entry summed with the lot sizes of all preceding bid-side entries included in said bid-side table.

11. The montage display process of claim 7 further comprising a bid-side selection process for allowing a market participant to select groups of said bid-side entries that have a common bid price.

12. The montage display process of claim 1 further comprising a security selection process for allowing a market participant of said montage display process to select said specific security.

13. The montage display process of claim 1 further comprising a security data display process for displaying trade data concerning said specific security.

14. The montage display process of claim 13 wherein said trade data includes a trade volume amount, a low trade amount, and a high trade amount.

15. A montage display method comprising:
displaying an ask-side entry, in a multi-column format, for a specific security that is offered for sale by a market participant on a securities market, wherein the ask-side entry includes a market participant identifier, a lot size, and an ask price; and
displaying a bid-side entry, in a multi-column format, for the specific security that is wanted for purchase by a market participant on a securities market, wherein the bid-side entry includes a market participant identifier, a lot size, and a bid price, wherein the bid-side entry is essentially a mirror image of the ask-side entry.

16. The montage display method of claim 15 wherein said displaying an ask-side entry includes simultaneously displaying multiple ask-side entries in an ask-side table.

17. The montage display method of claim 16 wherein said displaying an ask-side entry includes sorting the multiple ask-side entries in accordance with a user-defined sorting parameter.

18. The montage display method of claim 16 further comprising generating an ask-side aggregate value for a specific ask-side entry, wherein the ask-side aggregate value is equal to the lot size of that specific ask-side entry summed with the lot sizes of all preceding ask-side entries included in the ask-side table.

19. The montage display method of claim 16 further comprising allowing a market participant to select groups of ask-side entries that have a common ask price.

20. The montage display method of claim 15 wherein said displaying a bid-side entry includes simultaneously displaying multiple bid-side entries in a bid-side table.

21. The montage display method of claim 20 wherein said displaying a bid-side entry includes sorting the multiple bid-side entries in accordance with a user-defined sorting parameter.

22. The montage display method of claim 20 further comprising generating a bid-side aggregate value for a specific bid-side entry, wherein the bid-side aggregate value is equal to the lot size of that specific bid-side entry summed with the lot sizes of all preceding bid-side entries included in the bid-side table.

23. The montage display method of claim 20 further comprising allowing a market participant to select groups of bid-side entries that have a common bid price.

24. The montage display method of claim 15 further comprising allowing a market participant of said montage display method to select the specific security.

25. The montage display method of claim 15 further comprising displaying trade data concerning the specific security.

26. A computer program product residing on a computer readable medium having a plurality of instructions stored thereon which, when executed by the processor, cause that processor to:
display an ask-side entry, in a multi-column format, for a specific security that is offered for sale by a market participant on a securities market, wherein the ask-side entry includes a market participant identifier, a lot size, and an ask price; and
display a bid-side entry, in a multi-column format, for the specific security that is wanted for purchase by a market participant on a securities market, wherein the bid-side entry includes a market participant identifier, a lot size, and a bid price, wherein said bid-side entry is essentially a mirror image of said ask-side entry.

27. The computer program product of claim 26 wherein instructions to display an ask-side entry further includes instructions to sort the multiple ask-side entries in accordance with a user-defined sorting parameter.

28. The computer program product of claim 26 further comprising instructions to allow a market participant to select groups of ask-side entries that have a common ask price.

29. The computer program product of claim 26 wherein instructions to display a bid-side entry further includes instructions to sort the multiple bid-side entries in accordance with a user-defined sorting parameter.

30. The computer program product of claim 26 further comprising instructions to allow a market participant to select groups of bid-side entries that have a common ask price.

31. The computer program product of claim 26 further comprising instructions to generate an aggregate value for a specific bid-side or ask side entry, wherein the bid-side or ask side aggregate value is equal to the lot size of that specific bid-side or ask side entry summed with the lot sizes of all preceding bid-side or ask side entries included in a bid-side or ask side table.
